(19) United States
(12) Patent Application Publication
(10) Pub. No.: US 2012/0163458 A1
(43) Pub. Date: Jun. 28, 2012

(54) METHOD FOR SELECTIVE SUB-LAYER MACROBLOCK DECODING

(75) Inventors: Jun Young Lee, Busan (KR); KyungSu Kim, Seoul (KR)

(73) Assignee: ELECTRONICS AND TELECOMMUNICATION RESEARCH INSTITUTE, Daejeon (KR)

(21) Appl. No.: 13/313,035

(22) Filed: Dec. 7, 2011

(30) Foreign Application Priority Data
Dec. 23, 2010 (KR) 10-2010-0134041

(51) Int. Cl. H04N 7/32; H04N 7/26

(52) U.S. Cl. 375/240.15; 375/240.24; 375/E07.243; 375/E07.027

(57) ABSTRACT

A method for selective sub-layer macroblock decoding includes sorting macroblocks into a plurality of layers, resolving a data dependency between the layers of the macroblocks, identifying the presence of decoding of each of the macroblocks in a sub-layer based on the data dependency, and selectively decoding the macroblocks based on the identified result.

### CROSS-REFERENCES TO RELATED APPLICATIONS

The present application claims priority under 35 U.S.C 119(a) to Korean Application No. 10-2010-0134041, filed on Dec. 23, 2010, in the Korean Intellectual Property Office, which is incorporated herein by reference in its entirety set forth in full.

### BACKGROUND

Exemplary embodiments of the present invention relate to video decoding, and more particularly, to a method for selective sub-layer macroblock decoding, which selectively decodes each macroblock according to a data dependency between macroblocks.

Scalable video coding (SVC) may be defined as an extended version of existing video compression standards (H.264, MPEG-2/4, VC-1 etc.), and the standardization of H.264/SVC as an extended version of H.264 was completed in 2007.

The H.264/SVC supports various display resolutions, frame frequencies and quality levels. In the H.264/SVC, the size of a bit stream can also be extensively applied suitable for the capacity of a channel through which the bit stream is to be transmitted.

Thus, application fields of the H.264/SVC are extended to IPTV services, digital broadcasting services suitable for various receiver environments, and the like.

Since the SVC is defined an extended version of the H.264, almost all tools and concepts of the H.264 are used in the SVC. The SVC has spatial, temporal and quality extensibility. Particularly, the SVC has a layered approach so as to have the spatial extensibility. In the layered approach, data obtained by performing up-sampling on information of a sub-layer is required to restore a top layer. Since the resolution of a picture displayed becomes a resolution of the topmost layer, the resolution restoration of the sub-layer provides data necessary for the restoration of the topmost layer. Accordingly, a decoding process of the SVC is much more complicated that that of a video having one layer such as a decoding process of the H.264. Particularly, calculation complexity required in performing the up-sampling on data of the sub-layer occupies most of the decoding process.

Conventionally, a single-loop decoding method was used to decrease the calculation complexity. In the method, motion compensation is not performed in sub-layers but performed in only the topmost layer, thereby reducing complexity required in the motion compensation.

However, the single-loop decoding method still requires a large amount of calculation and memory in decoding.

Therefore, in order to implement real-time hardware and software, it is required to reduce overhead of decoding data of the sub-layers, including the up-sampling.

The technical configuration described above is a background art for better understanding of the present invention, but is not a prior art well-known in the technical field pertinent to the present invention.

### SUMMARY

An embodiment of the present invention relates to a method for selective sub-layer macroblock decoding, in which a sub-layer macroblock of a sub-layer, unnecessary to be decoded, is resolved and selectively decoded, so that overhead of decoding data of a sub-layer can be reduced, thereby decreasing the decoding complexity of the sub-layer.

In one embodiment, a method for selective sub-layer macroblock decoding includes sorting macroblocks into a plurality of layers, resolving a data dependency between the layers of the macroblocks, identifying the presence of decoding of each of the macroblocks in a sub-layer based on the data dependency, and selectively decoding the macroblocks based on the identified result.

In the step of sorting the macroblocks into the plurality of layers, the macroblocks may be sorted and layered into a plurality of macroblock types through a scalable video coding (SVC) decoding process.

The macroblock type may include a first type to perform a prediction in a picture and a prediction between pictures in the layers; a second type to perform a prediction between the layers and a prediction between the pictures; a third type to require residual signals of a sub-layer while performing a prediction between the layers and a prediction between the pictures; a fourth type to be a macroblock type in a sub-layer and have a data dependency between the layers; and a fifth type to be a macroblock type in a sub-layer and have no data dependency between the layers.

### BRIEF DESCRIPTION OF THE DRAWINGS

The above and other aspects, features and other advantages will be more clearly understood from the following detailed description taken in conjunction with the accompanying drawings, in which:

FIG. 1 illustrates a macroblock type diagram according to an embodiment of the present invention;

FIG. 2 illustrates a coding tree diagram between macroblocks between a sub-layer macroblock and an enhancement-layer macroblock with respect to an intra picture (P/B picture) picture according to the embodiment of the present invention;

FIG. 3 illustrates a coding tree diagram between a sub-layer macroblock and an enhancement-layer macroblock with respect to an inter picture (I picture) picture according to the embodiment of the present invention;

FIG. 4 is a flowchart illustrating a process of determining a sub-layer macroblock decoding according to an embodiment of the present invention; and

FIG. 5 is a flowchart illustrating a method for selective sub-layer macroblock decoding according to the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

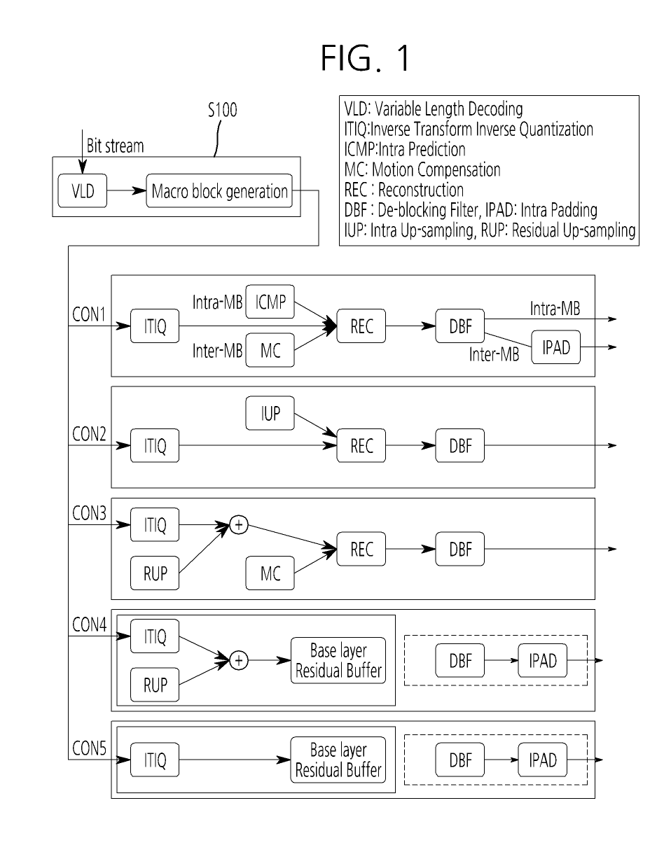

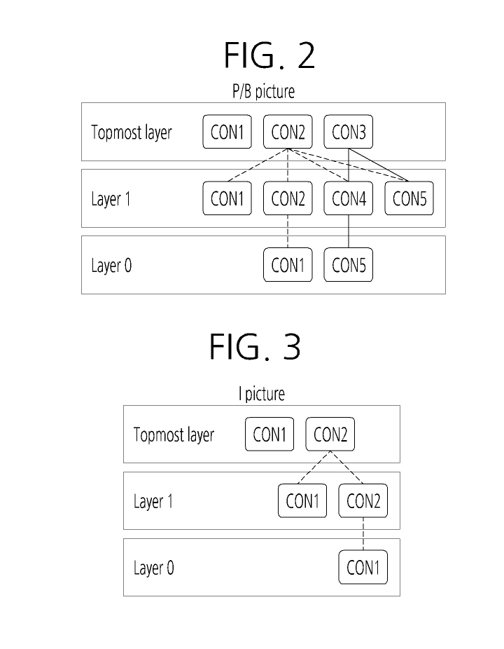

FIG. 1 illustrates a macroblock type diagram according to an embodiment of the present invention. FIG. 2 illustrates a coding tree diagram between a sub-layer macroblock and an enhancement-layer macroblock with respect to an intra picture (P/B picture) picture according to the embodiment of the present invention. FIG. 3 illustrates a coding tree diagram between a sub-layer macroblock and an enhancement-layer macroblock with respect to an inter picture (I picture) picture according to the embodiment of the present invention.

In general, the scalable video coding (SVC) uses a single-loop method. Thus, it is unnecessary to decode all macroblocks in a sub-layer. Accordingly, in the method for selective sub-layer macroblock decoding according to this embodiment, macroblocks are sorted, and a macroblock unnecessary to be decoded among the sorted macroblocks is selected, thereby selectively decoding the selected macroblock.

Referring to FIG. 1, macroblock types according to this embodiment are illustrated. Here, five macroblock types are illustrated.

A first type CON1 among the macroblock types is a type corresponding to general H.264, and performs a prediction in a picture and a prediction between pictures within one layer.

A second type CON2 among the macroblock types requires texture information of a sub-layer so as to perform a prediction between layers and a prediction between pictures.

A third type CON3 among the macroblock types requires residual signals (residuals) so as to perform a prediction between layers and a prediction between pictures.

The second and third types CON2 and CON3 among the macroblock types require a process of texture up-sampling and a process of residual up-sampling so as to obtain prediction signals from their sub-layers, respectively.

Fourth and fifth macroblock types CON4 and CON 5 among the macroblock types are macroblock types used in only a sub-layer as macroblocks for performing up-sampling of a top layer. In FIG. 1, blocks indicated by bold solid line are blocks for residual up-sampling, and blocks indicated by dotted line are blocks for texture up-sampling.

If the macroblock types are sorted, the macroblock types are divided into a plurality of layers, and a tree structure for macroblocks is formed according to data dependencies between the layers.

FIGS. 2 and 3 illustrates coding trees with respect to an intra picture (P/B picture) and an inter picture (I picture), respectively.

Each node represents a macroblock type used in each layer, and a dotted line indicates a data dependency between layers at each node.

FIG. 2 illustrates the coding tree constructed with respect to the P/B picture, and FIG. 3 illustrates the coding tree constructed with respect to the I picture. In FIGS. 2 and 3, CON1 to CON5 represent the respective types sorted according to this embodiment, and the dotted line indicates the data dependency.

Referring to FIG. 2, it can be seen that the second type CON2 in a topmost layer has data dependencies with the first, second, fourth and fifth types CON1, CON2, CON4 and CON5 in a second-level layer.

The second type CON2 in the topmost layer has a data dependency with the first type CON1 in a bottommost layer.

Referring to FIG. 3, it can be seen that the second type CON2 in the topmost layer has data dependencies with the first and second types CON1 and CON2 in the second-level layer, and the second type CON2 in the second-level layer has a data dependency with the first type CON1 in the bottommost layer.

Thus, the first and fifth types CON1 and CON5 have no data dependency. Accordingly, it can be seen that the fifth type CON5 is a macroblock unnecessary for decoding in a sub-layer.

If a coding tree is constructed with respect to all the macroblocks in the topmost layer, there exist macroblocks unnecessary for decoding in sub-layers.

Such macroblocks are previously resolved before being decoded, and decoding skip is performed on the macroblocks, thereby reducing overhead of sub-layer decoding.

As such, macroblocks in the sub-layers are sorted and the sorted macroblocks are decoded. To this end, header information of macroblocks are parsed and analyzed, and then sorted according to the macroblock types. Subsequently, macroblock sorting and selective sub-layer macroblock decoding are determined.

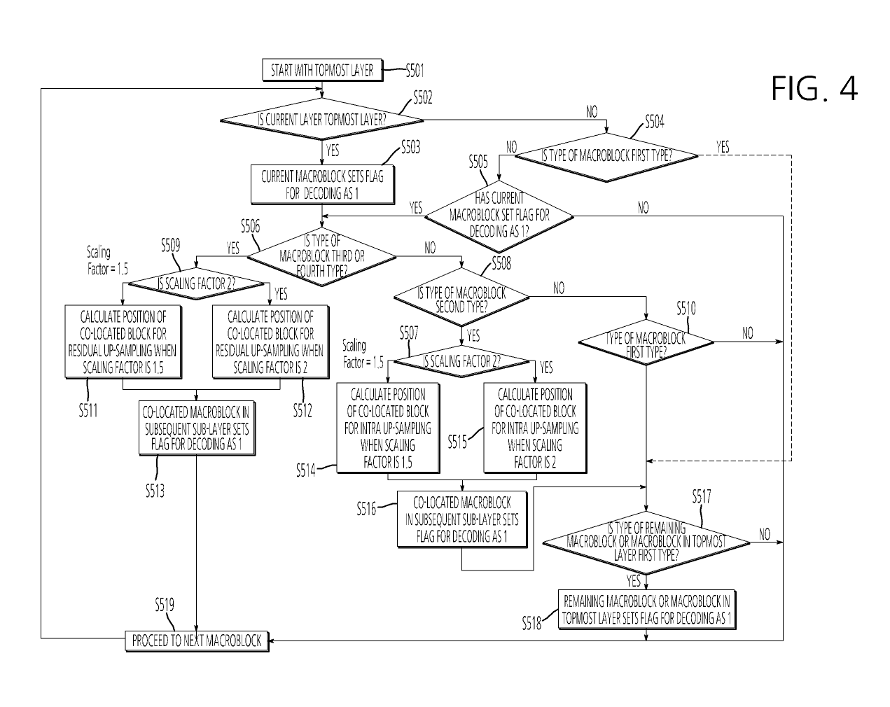

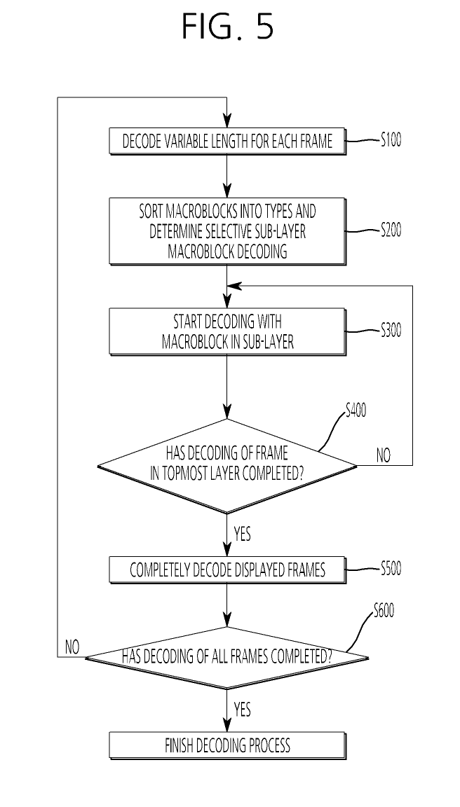

This will be described with reference to FIGS. 4 and 5.

FIG. 4 is a flowchart illustrating a process of determining selective sub-layer macroblock decoding according to an embodiment of the present invention.

First, headers of macroblocks are parsed for each frame, and the process is performed from the topmost layer to sub-layers.

If the macroblock type is a third or fourth type CON3 or CON4, the process includes a process of calculating a co-located block for residual up-sampling, and the decoding of macroblocks corresponding to the third or fourth type CON3 or CON4 is enabled.

Similarly, if the macroblock type is a second type CON2, the process includes a process of calculating a co-located block for texture up-sampling. In addition, the process includes a part for satisfying a data dependency between pictures.

For macroblocks of the first type, only the part for satisfying the data dependency between pictures is included in the process.

All the macroblocks from the topmost layer to the sub-layers are checked, and the process proceeds to the next frame. If the determination of sub-layer macroblock decoding is finished, substantial decoding is performed starting with macroblocks in the sub-layers based on the determination. If the decoding enable flag is ‘0,’ the decoding skip is performed. If the decoding enable flag is ‘1,’ the decoding of a corresponding macroblock is performed.

This will be described in detail with reference to FIG. 4.

That is, as illustrated in FIG. 4, the process is started with a topmost layer (S501), and it is identified whether a current layer is the topmost layer (S502). If the current layer is the topmost layer, a current macroblock sets a flag for decoding as 1 (S503). If the current layer is not the topmost layer, it is identified whether the type of the current macroblock is a first type (S504). If the type of the current macroblock is not the first type, it is identified whether the current macroblock has set the flag for decoding as 1 (S506). After the flag for decoding is set as 1 in the step S503 or when the flag for decoding is set as 1 in the step S505, it is identified whether the type of the macroblock is a third or fourth type (S506). If the type of the macroblock is the third or fourth type, it is identified whether the scaling factor of the macroblock is 2 (S507). If the scaling factor of the macroblock is 1.5, the position of a co-located block for residual up-sampling is calculated (S511). If the scaling factor of the macroblock is 2, the position of the co-located block for residual up-sampling is also calculated (S512). After the calculation is finished, a co-located macroblock in a subsequent sub-layer sets a flag for decoding as 1 (S513).

If the type of the macroblock is not the third or fourth type in the step S506, it is identified whether the type of the macroblock is a second type (S508). If the type of the macroblock is the second type, it is identified whether the scaling factor of the macroblock is 2 (S509). If the scaling factor of the macroblock is 1.5, the position of the co-located block for intra up-sampling is calculated (S514). If the scaling factor of the macroblock is 2, the position of the co-located block for intra up-sampling is also calculated (S515). After the calculation is finished, a co-located macroblock in a subsequent sub-layer sets a flag for decoding as 1. (S516). If the type of the macroblock is not the second type in the step S508, it is identified whether the type of the macroblock is the first type (S510).

If the type of the macroblock is the first type in the step S504 and if the type of the macroblock is the first type in the step S510, it is identified whether the type of a macroblock remaining after the step S516 is finished or macroblock in the topmost layer is the first type (S517). If the type of the remaining macroblock or macroblock in the topmost layer is the first type, the remaining macroblock or macroblock in the topmost layer sets a flag for decoding as 1 (S518).

If the flag for decoding, set by the macroblock, is not 1 in the step S505, if the type of the macroblock is not the first type in the step S510 and if the process passes through the step S513 or S518, the process proceeds to the next macroblock and re-starts with the step S502 for identifying whether or not a current layer is a topmost layer (S519).

FIG. 5 is a flowchart illustrating a method for selective sub-layer macroblock decoding according to the embodiment of the present invention.

In the method according to this embodiment, a variable length is decoded for each frame (S100).

Subsequently, macroblocks are sorted into a plurality of types, and a macroblock in a sub-layer to be decoded is selected (S200). Here, the process of selecting the macroblock in the sub-layer to be decoded will be described with reference to FIG. 5.

If the macroblock in the sub-layer to be decoded is selected, decoding is started with the macroblock in the sub-layer (S300).

Subsequently, it is identified whether the frame in a topmost layer has been decoded (S400). If it is identified that the frame in the topmost layer has not been decoded, the decoding process (S300) is repeated from the macroblock in the sub-layer.

If the frame in the topmost layer is decoded so that displayed frames are all decoded (S500), it is identified whether the decoding of the whole frames has been completed (S600).

If the decoding of the whole frames has not been completed, the whole frames are decoded by repeatedly performing the processes (S100 to S500).

If the decoding of the whole frames is completed, the decoding process is finished (S700).

As described above, according to the present invention, it is possible to remarkably reduce overhead of sub-layer decoding, which occurs when performing scalable video decoding.

In the configuration of an SVC real-time decoder, it is possible to perform decoding at a level similar to an existing H.264 decoder and to implement real-time hardware and software.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method for decoding a selective sub-layer macroblock, the method comprising:
sorting macroblocks into a plurality of layers;
resolving a data dependency between the layers of the macroblocks;
identifying the presence of decoding of each of the macroblocks in a sub-layer based on the data dependency; and
selectively decoding the macroblocks based on the identified result.

2. The method of claim 1, wherein, in the step of sorting the macroblocks into the plurality of layers, the macroblocks are sorted and layered into a plurality of macroblock types through a scalable video coding (SVC) decoding process.

3. The method of claim 2, wherein, the macroblock types comprises:
a first type to perform a prediction in a picture and a prediction between pictures in the layers;
a second type to perform a prediction between the layers and a prediction between the pictures;
a third type to require residual signals of a sub-layer while performing a prediction between the layers and a prediction between the pictures;
a fourth type to be a macroblock type in a sub-layer and have a data dependency between the layers; and
a fifth type to be a macroblock type in a sub-layer and have no data dependency between the layers.

4. The method of claim 3, wherein, when the type of the macroblock is the second type, the step of decoding comprises calculating a co-located block for texture up-sampling.

5. The method of claim 3, wherein, when the type of the macroblock is the third or fourth type, the step of decoding comprises calculating a co-located block for residual up-sampling.
